(19) United States
(12) Patent Application Publication
(10) Pub. No.: US 2018/0170123 A1
(43) Pub. Date: Jun. 21, 2018

(54) UV-CURABLE RUBBER AS ANTENNA COMPONENT OF THE TREAD

(71) Applicant: Bridgestone Americas Tire Operations, LLC, Nashville, TN (US)

(72) Inventors: Adam K. Nesbitt, Akron, OH (US); Joshua P. Abell, Franklin, TN (US)

(21) Appl. No.: 15/842,097

(22) Filed: Dec. 14, 2017

Related U.S. Application Data
(60) Provisional application No. 62/436,849, filed on Dec. 20, 2016.

(51) Int. Cl. B60C 19/08; B60C 11/00; B60C 1/00; C08K 3/04; C08K 3/36; C08K 3/08; C08K 5/00; C08L 9/00

(52) U.S. Cl. CPC B60C 19/082; B60C 11/005; B60C 1/0016; C08K 3/04; C08K 3/041; C08K 2201/011; C08K 3/36; C08K 3/08; C08K 5/0025; C08L 9/00; C08K 2201/001; C08K 3/042

(57) ABSTRACT

The present disclosure relates to a pneumatic tire having at least one electrically conductive pathway capable of dissipating electrostatic charges generated in a vehicle to a road surface while achieving low rolling resistance and improved wet traction tire performances. The pneumatic tire has a tread portion which includes a tread cap layer forming a ground contacting surface and a tread base layer underlying the tread cap layer. The tread cap layer contains at least one electrically conductive pathway locally extending from the ground-contacting surface of the tread cap layer to contact the tread base layer. The electrically-conductive pathway is composed of a UV-cured rubber composition which is electrically conductive.

This application claims the benefit of U.S. provisional application Ser. No. 62/436,849 filed Dec. 20, 2016, the contents of which are incorporated herein in their entirety by reference.

### TECHNICAL FIELD

The present disclosure relates to a pneumatic tire having at least one electrically conductive pathway capable of dissipating electrostatic charges generated in a vehicle to a road surface. The pneumatic tire has a tread portion which includes a tread cap layer forming a ground contacting surface and a tread base layer underlying the tread cap layer. The tread cap layer contains at least one electrically conductive pathway locally extending from the ground-contacting surface of the tread cap layer to contact the tread base layer. The electrically-conductive pathway is composed of a UV-cured rubber composition which is electrically conductive.

### BACKGROUND

Conventionally tire tread compositions contain a substantial amount of carbon black which functions as a reinforcing filler and also provides adequate electrical conductivity to the tire, thereby preventing electrostatic charge accumulation in tires and vehicles. In the drive for continuous improvement in fuel efficiency and wet traction tire performances in the tire industry, the carbon black in tread compositions has been significantly reduced to a minimal loading level, if any, and has been replaced by silica. The silica brings in advantages of lower rolling resistance and improved wet traction tire performances. However, the silica is electrically non-conductive and therefore reduces the electrical conductivity of the silica reinforced tires compared to the carbon black reinforced tires. Consequently, tread compositions reinforced with a large amount of silica and a minimal level of carbon black may result in electrostatic charge accumulation in tires and vehicles and give rise to noise, adverse influence of the circuit board, or other performance disadvantages.

To reduce the electrostatic charge buildup in tires and vehicles, a number of solutions have been proposed. One technique is to employ special grades of electrically-conductive carbon black in the tread composition, such as Ketjenblack® EC-300J and EC-600JD. BLACK PEARLS® 2000, and so on. Although this approach is effective in improving the electrical conductivity and thus dissipating the electrostatic charge, it deteriorates the low rolling resistance of the tire and consequently reduces the effectiveness of silica in improving the fuel efficiency. Furthermore, this approach is costly.

Another approach is to incorporate into tread compositions anti-static agents such as surfactants. An anti-static effect for tires is displayed by causing an anti-static agent to bloom on the surface of tire tread portion to form a hydrophilic, and therefore, conductive film. However, the conductive film is easily abraded away once tire treads operate on a rough road surface. The film cannot be expected to grow, thus these anti-static agents are not as effective when applied in tires.

EP 0853010 discloses a rubber tire having a tread composed of a ground-contacting tread layer made of a relatively low electrical conductivity rubber composition, and tread wings composed of a relatively high electrical conductivity rubber composition, and a thin gum strip of relatively high electrical conductivity rubber composition positioned on a portion of the face of the tread and extending into the interface between the tread and the tread wings. Such an approach requires extra manufacturing steps and can be ineffective should the discharge gum strip wear away at the tread shoulder area.

U.S. Pat. No. 5,942,069 discloses a pneumatic vehicle tire having a tire tread layer which is made from an electrically insulating layer and an electrically conductive layer beneath the tread layer. In order to effectively dissipate electrostatic charge, the electrically conductive layer extends radially at least regionally up to and into the tire running-surface, which is so called an electrically conductive chimney. Such a method requires a complex and costly manufacturing method and equipment as depicted in U.S. Pat. No. 6,746,227.

It is an objective of the present disclosure to overcome one or more difficulties related to the prior art. The present invention utilizes an inexpensive, effective, and reliable technique to provide an electrically conductive pathway through the tread to reduce the tire electrical resistance and therefore effectively dissipate electrostatic charge generated in tires or vehicles. One advantage of the present invention is that the tire can achieve high electrical conductivity while maintaining the low rolling resistance, improved wet traction and desirable treadwear tire performances by forming electrically conductive pathways locally. Furthermore, the electrically conductive pathway can be formed during the manufacturing process of a new tire, a tire for retreading purposes, or after the tire manufacturing process, for example, into a new or used tire for purposes of repair to fix the electrical conductivity issues.

### SUMMARY

In a first aspect, a pneumatic tire contains a tread portion which includes a tread cap layer and a tread base layer, wherein the tread cap layer having a ground-contacting surface, and the tread cap layer being composed of a tread cap composition; the tread base layer underlying the tread cap layer, and the tread base layer being composed of a tread base composition; the tread cap layer contains at least one electrically-conductive pathway extending from the ground-contacting surface of the tread cap layer to the tread base layer; and the pathway being composed of a UV-cured rubber composition, wherein the UV-cured rubber composition is a UV-curable liquid rubber composition cured by UV light.

In an example of aspect 1, the UV-cured rubber composition is electrically conductive.

In another example of aspect 1, the electrical conductivity of the UV-cured rubber composition is higher than 1×10⁻⁸ S/cm.

In another example of aspect 1, the electrical conductivity of the UV-cured rubber composition is higher than 1×10⁻⁶ S/cm.

In another example of aspect 1, the electrically-conductive pathway is formed during a tire manufacturing process, wherein the tread cap layer is in an uncured green state.

In another example of aspect 1, the electrically-conductive pathway is formed during a tire manufacturing process, wherein the tread cap layer, the tread base layer and the tire are in an uncured green state.

In another example of aspect 1, the electrically-conductive pathway is formed by steps including: forming a cavity in the green tread cap layer, the cavity extending from the ground-contacting surface of the tread cap layer to the tread base layer; filling the cavity with the UV-curable liquid rubber composition, for instance fully filled or over filled; exposing a surface of the UV-curable liquid rubber composition to UV light to form a partially UV-cured liquid rubber composition; and co-curing the partially UV-cured liquid rubber composition with the green tread cap layer and green tread base layer during a tire curing process.

In another example of aspect 1, the electrically conductive pathway is formed after a tire manufacturing process, wherein the tire cap layer is in a cured state.

In another example of aspect 1, the electrically conductive pathway is formed by steps including: forming a cavity on a cured tire tread cap layer and the cavity extending from the ground-contacting surface of the tread cap layer to the tread base layer; filling the cavity with the UV-curable liquid rubber composition, for instance fully filled or until over filled by at least 1, 5 or 10 percent, while applying UV-light to the UV-curable liquid rubber composition or without applying UV-light; and further applying UV-light after filling the cavity to cure the UV-curable liquid rubber composition.

In another example of aspect 1, the electrically-conductive pathway is a cavity in any shape having an average diameter in the range of about 1 mm to about 30 mm.

In another example of aspect 1, the electrically-conductive pathway is a cavity in any shape having an average diameter in the range from about 3 mm to about 20 mm.

In another example of aspect 1, the tread cap layer is electrically non-conductive.

In another example of aspect 1, the tread base layer is electrically conductive.

In another example of aspect 1, the electrical conductivity of the tread base layer is higher than 1×10⁻⁸ S/cm.

In another example of aspect 1, the electrical conductivity of the tread base payer is higher than 1×10⁻⁶ S/cm.

In another example of aspect 1, the electrically-conductive pathway is entirely composed of the UV-cured rubber composition.

In another example of aspect 1, the electrically-conductive pathway is encased along its radial length by the tread cap layer.

In another example of aspect 1, the UV-curable liquid rubber composition contains:
(a) polyfunctionalized diene monomer-containing polymer having the formula:
   [P][F]ₙ where P represents a diene polymer chain and includes monomers selected from the group consisting of 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene, 2,4-hexadiene, 1,3-cyclopentadiene, 1,3-cyclohexadiene, 1,3-cycloheptadiene, 1,3-cyclooctadiene, farnescene, and substituted derivatives of each of the foregoing.
   F represents a functional group, n is in the range from 2 to about 15, and each F can be the same or different; each F is selected from the group consisting of acrylate, methacrylate, cyanoacrylate, epoxide, aziridine, and thioepoxide.
(b) optionally a chain extender based upon F or reactive with F;
   wherein the chain extender having an (meth)acrylate monomer selected from C2 to about C18 alkyl functionalized (meth)acrylates with T_{g} of about −65° C. to about 10° C. and the number average molecular weight of about 70 to about 135,000 grams per mole;
(c) at least one UV-light sensitive photoinitiator,
(d) optionally, a photosensitizer;
(e) a polyfunctional crosslinker reactive with F; and
(f) at least one electrically conductive filler selected from the group consisting of conductive grades of carbon black, reinforcing grades of carbon black, carbon nanotubes, graphene, expanded graphite, metal particles, electrically conductive polymers, silica, and doped electrically conductive polymers.

In another example of aspect 1, the UV-curable liquid rubber composition may further contain at least one liquid diene rubber which has a number molecular weight Mₙ higher than 1,000 grams per mole, preferably in the range of 5,000 to 300,000 grams per mole, more preferably in the range of 6,000 to 100,000 grams per mole, wherein the liquid diene rubber may be selected from the group consisting of liquid styrene butadiene rubber, liquid butadiene rubber, liquid polyisoprene, liquid isoprene-butadiene rubber, and liquid farnescene.

In another example of aspect 1, the photoinitiator in the UV-curable liquid rubber composition meets at least one of the following conditions:
a. the photoinitiator is selected from the group consisting of benzophenone, aromatic α-hydroxyketone, benzilketal, aromatic α-aminoketone, phenylglyoxalic acid ester, mono-acylphosphinoxide, bis-acylphosphinoxide, and tris-acylphosphinoxide;
b. the photoinitiator is selected from the group consisting of benzophenone, benzildimethylketal, 1-hydroxy-cyclohexyl-phenyl-ketone, 1-[4-(2-hydroxyethoxy)-phenyl]-2-hydroxy-2-methyl-1-propan-1one, 2-hydroxy-1-{4-[4-(2-hydroxy-2-methyl-propionyl)-benzyl]-phenyl}-2-methyl-propan-1-one, (4-methylthiobenzoyl)-1-methyl-1-morpholinoethane, (4-morpholinobenzoyl)-1-benzyl-1-dimethylaminopropane, (4-morpholinobenzoyl)-1-(4-methylbenzyl)-1-dimethylaminopropane, (2,4,6-trimethylbenzoyl)diphenylphosphine oxide, bis(2,6-dimethoxy-benzoyl)-(2,4,4-trimethyl-pentyl)phosphine oxide, bis(2,4,6-trimethylbenzoyl)-phenylphosphine oxide and 2-hydroxy-1-{1-[4-(2-hydroxy-2-methyl-propionyl)-phenyl]-1,3,3-trimethyl-indan-5-yl}-2-methyl-propan-1-one, 1,2-octanedione, 1-[4-(phenylthio)phenyl]-,2-(O-benzyloxime), oligo[2-hydroxy-2-methyl-1-[4-methylvinyl]phenyl]propanone, 2-hydroxy-2-methyl-1-phenyl propan-1-one, and combinations thereof; or
c. the photoinitiator is selected from the group consisting of benzoin, aryl ketone, alpha-amino ketone, mono- or bis(acyl)phosphine oxide, benzoin alkyl ether, benzil ketal, phenylglyoxalic ester or derivatives thereof, oxime ester, per-ester, a ketosulfone, phenylglyoxylate, borate, and metallocene.

In another example of aspect 1, the photosensitizer is selected from the group consisting of ketocoumarin, xanthone, thioxanthone, polycyclic aromatic hydrocarbon, and oximester derived from aromatic ketone.

In another example of aspect 1, the polyfunctional crosslinker in the UV-curable liquid rubber composition meets at least one of the following conditions:
a. the polyfunctional crosslinker is selected from the group consisting of polyol (meth)acrylates prepared from an aliphatic diol, triol, or tetraol containing 2-100 carbon atoms, polyallylic compounds prepared from an aliphatic diol, triol or tetraol containing 2-100 carbon atoms, polyfunctional amines, or combinations thereof; or
b. the polyfunctional crosslinker is selected from the group consisting of: trimethylolpropane tri(meth)acrylate, pentaerythritol tetraacrylate, pentaerythritol triacrylate, trimethylolpropane ethoxylate triacrylate, acrylated epoxidized soybean oil, ditrimethylol propane tetraacrylate, di-pentaerythritol polyacrylate, di-pentaerythritol polymethacrylate, di-pentaerythritol triacrylate, di-pentaerythritol trimethacrylate, di-pentaerythritol tetracrylate, di-pentaerythritol tetramethacrylate, di-pentaerythritol pent(meth)acrylate, di-pentaerythritol hexa(meth)acrylate, pentaerythritol poly(meth)acrylate, pentaerythritol tri(meth)acrylate, pentaerythritol tetra(meth)acrylate, pentaerythritol penta(meth)acrylate, pentaerythritol hexa(meth)acrylate, ethoxylated glycerine triacrylate, ε-caprolactone ethoxylated isocyanuric acid triacrylate and ethoxylated isocyanuric acid triacrylate, tris(2-acryloxyethyl) isocyanulate, propoxylated glyceryl triacrylate, ethyleneglycol diacrylate, 1,6-hexanediol diacrylate, neopentylglycol di(meth)acrylate, ethyleneglycol dimethacrylate (EDMA), polyethyleneglycol di(meth)acrylates, polypropyleneglycol di(meth)acrylates, polybutyleneglycol di(meth)acrylates, 2,2-bis(4-(meth)acryloxyethoxyphenyl) propane, 2,2-bis(4-(meth)acryloxydiethoxyphenyl) propane, di(trimethylolpropane) tetra(meth)acrylate, and combinations thereof

In another example of aspect 1, the UV-curable liquid rubber composition further includes a thermally curable cure package containing sulfur, zinc oxide, and a primary accelerator. Optionally it may further contain an activator and/or a retarder. The primary accelerator is selected from the group consisting of N-cyclohexyl-2-benzothiazole sulfonamide (CBS), N-tert-butyl-2-benzothiazole sulfonamide (TBBS), benzothiazyl disulfide (MBTS), tetrabutylthiuram disulfide (TBTD), and 2-(morpholinothio)benzothiazole (MBS).

In another example of aspect 1, the UV-curable liquid rubber composition further includes a thermally-curable organic peroxide package, which may contain an organic peroxide and optionally a coagent. The organic peroxide is selected from the group consisting of dicumyl peroxide, α,α′-bis(t-butylperoxy)diisopropylbenzene, and the mixtures thereof. The coagents may be selected from the group consisting of octyl acrylate, decyl acrylate, 1,6-hexanediol diacrylate, zinc diacrylate, zinc dimethacrylate, trimethylolpropane triacrylate, pentaerythritol tetraacrylate, dipentaerythritol pentaacrylate, triallyl cyanurate, triallyl isocyanurate, high vinyl polybutadiene, and mixtures thereof.

The first aspect may be provided alone or in combination with any one or more of the examples of the first aspect discussed above.

In a second aspect, there is a method of making a tire capable of dissipating electrostatic charge in a vehicle during a manufacturing process of a new tire or a manufacturing process of a tire for retreading purposes, the method including steps of forming a cavity in an uncured green tread cap layer with the cavity extending from a ground-contacting surface of the tread cap layer to a tread base layer underlying the tread cap layer; filling the cavity with a UV-curable liquid rubber composition fully or until overly filled by 10%; exposing a surface of the UV-curable liquid rubber composition to UV light to partially cure the UV-curable liquid rubber composition; and co-curing the UV-curable liquid rubber composition with the uncured green tread cap layer.

In one example of aspect 2, the tread base layer is in an uncured green state.

In another example of aspect 2, the tread base layer and the tire are in an uncured green state.

The second aspect may be provided alone or in combination with any one or more of the examples of the second aspect discussed above, or with any one or more of the examples of the first aspects.

In a third aspect, there is a method of making a tire capable of dissipating electrostatic charge in a vehicle after a tire manufacturing process, the method including steps of forming a cavity in a cured tread cap layer of a cured tire with the cavity extending from a ground-contacting surface of the tread cap layer to a tread base layer underlying the tread cap layer; filling the cavity with a UV-curable liquid rubber composition fully or until overly filled by 10%; and applying UV-light to cure the UV-curable liquid rubber composition.

The third aspect may be provided alone or in combination with any one or more of the examples of the third aspect discussed above, or with any one or more of the examples of the first and second aspects.

The accompanying drawings are included to provide a further understanding of principles of the invention, and are incorporated in and constitute a part of this specification. The drawings illustrate one or more embodiment(s), and together with the description serve to explain, by way of example, principles and operation of the invention. It is to be understood that various features disclosed in this specification and in the drawings can be used in any and all combinations. By way of non-limiting example the various features may be combined with one another as set forth in the specification as aspects.

### BRIEF DESCRIPTION OF THE DRAWINGS

The above description and other features, aspects and advantages are better understood when the following detailed description is read with reference to the accompanying drawings, in which:

FIG. 1 is a cross-sectional view of a tire along the width direction showing electrically conductive pathway extending from the ground-contacting surface of a tread cap layer to a tread base layer underling and in contact with the tread cap layer.

FIG. 2 shows a cross-sectional view of a tire tread portion having a tread cap layer, a tread base layer and one electrically conductive pathway overfilled with a UV-curable liquid rubber composition arranged in a tread rib in the tread cap layer.

FIG. 3 shows a cross-sectional view of a tire tread portion having a tread cap layer, a tread base layer and one electrically conductive pathway filled with a UV-cured rubber composition arranged in the tread cap layer.

FIG. 4 shows a perspective view of a tire with various locations and distribution of one or more electrically conductive pathways arranged in the tread portion.

### DETAILED DESCRIPTION

The terminology as set forth herein is for description of the embodiments only and should not be construed as limiting the invention as a whole. Any reference to the “invention” may refer to one or more, but not necessarily all, of the inventions defined by the claims.

Herein, when a range such as 5-25 (or 5 to 25) is given, this means preferably at least or more than 5 and, separately and independently, preferably not more than or less than 25. In an example, such a range defines independently at least 5, and separately and independently, not more than 25.

Unless specified otherwise, phr of an ingredient in a rubber composition means part by weight of the ingredient based on 100 parts by weight of total elastomers in the rubber composition. In an example, a rubber composition has 5 phr of carbon black means that the rubber composition has 5 parts by weight of carbon black based on 100 parts by weight of elastomers, present in the rubber composition.

In the description, the terms “cured,” “cure” or “curable,” may on occasion, be used interchangeably with the terms of “vulcanized,” “vulcanization” or “vulcanizable” respectively.

The present disclosure is directed to a pneumatic tire having improved electrical conductivity in its tread portion and at the same time, preferably maintaining low rolling resistance and improved wet traction tire performances. The pneumatic tire has a tread portion that includes a tread cap layer forming a ground-contacting surface and a tread base layer underlying and, in some examples in contact with the tread cap layer. The tread cap layer is composed of a tread cap composition, and the tread base layer is composed of a tread base composition which can be different from the tread cap composition and the UV-curable liquid rubber composition described herein. The improved electrically conductivity of the tire is achieved by forming at least one electrically-conductive pathway locally within the tread cap layer, extending from the ground-contacting surface (e.g., a tread lug surface) of the tread cap layer to the tread base layer. The electrically-conductive pathway is composed of a UV-cured rubber composition which is formed from a UV-curable liquid rubber composition cured by UV-light.

The UV-cured rubber composition is electrically conductive to form an electrically-conductive pathway through the tread cap layer. It has an electrical conductivity higher than 1×10⁻⁸ S/cm, or higher than 1×10⁻⁷ S/cm, or even higher than 1×10⁶ S/cm. For certain tire applications, such as Class-A truck tires for transporting flammable and explosive goods, the UV-cured rubber composition can have an electrical conductivity higher than 1×10⁶ S/cm.

In tire industry, in order to achieve lower rolling resistance and improved wet traction tire performances, the carbon black has been significantly reduced in loading level in the tire tread cap layer and has been replaced with silica. With the decrease of the loading level of carbon black, the electrical conductivity of tire tread cap layer is reduced. When the loading level of carbon black is reduced to be less than 40 phr, the electrical conductivity of the tread cap layer can be considered undesirable or electrically non-conductive and the electrostatic charge accumulation in a vehicle can increase. This is sometimes seen in certain tires reinforced partially with carbon black with loading levels in the range of 10 phr to 40 phr and partially with precipitated silica with loading levels in the range from 5 phr to 120 phr, or from 20 phr to 100 phr. The tread cap layer is further electrically non-conductive when the loading level of carbon black is less than about 10 phr, as typical in consumer tires. Further for tires with tread cap layer having carbon black in the range from about 40 phr to about 60 phr, the electrical conductivity may not be sufficiently high to effectively dissipate electrostatic charge, especially after constant deformation over a period of a few years of operation on vehicles.

Therefore an electrical conductivity pathway is desirable for tires with a tread cap layer with carbon black content less than 40 phr, and especially for tires with tread cap layer having carbon black content less than about 30, 20, or 10 phr or less. For tires with tread cap layer having carbon black content in the range from about 40 phr to about 60 phr, an electrical conductivity pathway on the tread cap layer is still desirable and can dissipate residual electrostatic charges, for example, after certain tire service life.

In one embodiment, the tread cap layer may be electrically non-conductive. The tread cap layer composition may contain, for example, a carbon black content less than 60, 40, 30, 20, or 10 phr for consumer and commercial tire applications.

The tread base layer is preferably electrically conductive. It can have an electrical conductivity higher than 1×10⁻⁸ S/cm or higher than 1×10⁻⁷ S/cm. For certain tire applications, the electrical conductivity may be even higher than 1×10⁶ S/cm. In order for the tread base layer to be sufficiently conductive to dissipate the electrostatic charges, the tread base layer composition can have carbon black content of more than 40 phr, preferably more than 50 phr and more preferably more than 60 phr.

It is readily understood by those having skills in the art that the layers of the tread portion, e.g., tread cap layer and tread base layer, are composed of rubber-containing compositions. The compositions can include 100 phr of any suitable tread elastomer, e.g., natural rubber, synthetic rubber, or a combination thereof. As used herein, the terms elastomer and rubber will be used interchangeably. Examples of suitable tread elastomers that may be used in the compositions described herein include, but are not limited to, natural rubber, synthetic polyisoprene rubber, styrene-butadiene rubber (SBR), styrene-isoprene rubber, styrene-isoprene-butadiene rubber, butadiene-isoprene-styrene terpolymer, butadiene-isoprene rubber, polybutadiene (PBD), butyl rubber, neoprene, acrylonitrile-butadiene rubber (NBR), silicone rubber, the fluoroelastomers, ethylene acrylic rubber, ethylene-propylene rubber, ethylene-propylene terpolymer (EPDM), ethylene vinyl acetate copolymer, epichlorohydrin rubber, chlorinated polyethylene-propylene rubbers, chlorosulfonated polyethylene rubber, hydrogenated nitrile rubber, terafluoroethylene-propylene rubber and combinations thereof. In one embodiment, the tread rubber compositions can include only natural rubber. A mixture of two or more elastomers may be used, for example, the tread rubber compositions may include a mixture of natural rubber and synthetic rubber (e.g., styrene-butadiene rubber or polybutadiene rubber).

In one or more embodiments, the tread portion layers can include compositions having one or more reinforcing fillers. The filler may be selected from the group consisting of carbon black, silica, and mixtures thereof. The total amount of filler may be from 1 to 200 phr, alternatively from 5 to 140 phr, from 30 phr to 130 phr, from 40 to 125 phr, or from 50 to 120 phr.

Carbon black, when present, may be used in an amount of 1 to 200 phr, in an amount of 5 to 100 phr, in an amount of 15 to 90 phr, or alternatively in an amount of 30 to 80 phr. Suitable carbon blacks include commonly available, commercially-produced carbon blacks, but those having a surface area of at least 20 m²/g, or preferably, at least 35 m²/g and up are preferred. Among useful carbon blacks are furnace blacks, channel blacks, and lamp blacks. A mixture of two or more carbon blacks can be used. Exemplary carbon blacks include, but are not limited to, N-110, N-220, N-339, N-330, N-352, N-550, N-660, as designated by ASTM D-1765-82a.

Examples of reinforcing silica fillers which can be used include wet silica (hydrated silicic acid), dry silica (anhydrous silicic acid), chemically pretreated silica, calcium silicate, and the like. Among these, precipitated amorphous wet-process, hydrated silica is preferred. Silica can be employed in an amount of 1 to 140 phr, in an amount of 5 to 125 phr, or alternatively in an amount of 30 to 110 phr. The useful upper range is limited by the high viscosity imparted by fillers of this type. Some of the commercially available silicas which can be used include, but are not limited to, HiSil 190, HiSil 210, HiSil 215, HiSil 233, HiSil 243, and the like, produced by PPG Industries (Pittsburgh, Pa.). A number of useful commercial grades of different silicas are also available from Evonik Industries (e.g., VN2, VN3), Solvay International Chemical Group (e.g., Zeosil 1165 MPO), and J. M. Huber Corporation.

The surface of the carbon black and/or silica may optionally be treated or modified to improve the affinity or chemical bonding to particular types of polymers. Such surface treatments and modifications are well known to those skilled in the art.

In one or more embodiments, the tread portion compositions may include ingredient of zinc oxide. Other ingredients that may be added to the tread rubber composition include, but are not limited to, oils, waxes, scorch inhibiting agents, tackifying resins, reinforcing resins, fatty acids such as stearic acid, antioxidants and antiozonants and peptizers. These ingredients are known in the art, and may be added in appropriate amounts based on the desired physical and mechanical properties of the rubber composition.

Vulcanizing agents and vulcanization accelerators may also be added to the tread portion compositions. Suitable vulcanizing agents and vulcanization accelerators are known in the art, and may be added in appropriate amounts based on the desired physical, mechanical, and cure rate properties of the rubber compositions. Examples of vulcanizing agents include sulfur and sulfur donating compounds. The amount of the vulcanizing agent used in the rubber compositions may, in certain embodiments, be from 0.1 to 15 phr, or from 1 to 10 phr.

When utilized, the particular vulcanization accelerator is not particularly limited. Numerous accelerators are known in the art and include, but are not limited to, diphenyl guanidine (DPG), tetramethylthiuram disulfide (TMTD), 4,4′-dithiodimorpholine (DTDM), tetrabutylthiuram disulfide (TBTD), benzothiazyl disulfide (MBTS), 2-(morpholinothio)benzothiazole (MBS), N-tert-butyl-2-benzothiazole sulfonamide (TBBS), N-cyclohexyl-2-benzothiazole sulfonamide (CBS), and mixtures thereof.

Organic peroxides and coagents may also be used for vulcanization of the tread portion compositions. A number of peroxides are known in the art and include, but are not limited to, dicumyl peroxide and α,α′-bis(t-butylperoxy)diisopropylbenzene. The coagents may include, but are not limited to, octyl acrylate, decyl acrylate, 1,6-hexanediol diacrylate, zinc diacrylate, zinc dimethacrylate, trimethylolpropane triacrylate, triallyl cyanurate, triallyl isocyanurate, and high vinyl polybutadiene.

In one or more embodiment, the pneumatic tire with at least one electrically conductive pathway formed locally on a tread cap layer can be practiced in the form of a tread on a new tire, in the form of a tread for retreading purposes, or can be further practiced in the form of a tread on a new or used cured tire for purpose of repair to fix the electrical conductivity of the tires.

The present disclosure is also directed to a method of manufacturing the electrically conductive pathway locally on a tread cap layer of a tire by using a UV-curable liquid rubber composition during a manufacturing process of a new tire or during a manufacturing process of a tread for tires for retreading purposes. The method includes the steps of 1) forming a cavity through a tread cap layer, for example the cavity extending from the ground-contacting surface of an uncured green tread cap layer to a tread base layer underlying the tread cap layer; 2) filling a UV-curable liquid rubber composition into the cavity in the tread cap layer; 3) optionally exposing a surface (e.g., a surface adjacent to or in contact with the ground-contacting surface of the tread cap layer) of the UV-curable liquid rubber composition to UV light to be partially cured; and 4) co-curing (e.g., thermal or a combination of thermal and UV), in the case of a uncured green tread cap, the UV-curable liquid rubber composition with the green tread cap layer.

As used herein, exposure of a surface, portion or the entire amount of the UV-curable liquid rubber composition to ultraviolet (UV) light, for example as it resides in the cavity in the tread cap layer, any suitable UV light source can be used. Any of various optical sources known in the art for effectively applying UV such as a carbon-arc lamp, a mercury-vapor arc lamp, an ultra-high pressure mercury lamp, a high-pressure mercury lamp, and a xenon lamp is used as the optical source used for the above-mentioned UV irradiation. Other sources, for example, flood systems, spot systems or conveyors that expose the UV-curable liquid rubber composition to UV light can likewise be used.

In one embodiment, the cavity is formed into an uncured green tread cap layer through the whole depth of the tread cap layer by a die cutting process using a die cutting machine, such as a rubber sheet die cutting press machine. Subsequently, the trade cap layer with the cavity is assembled with the tread base layer and other components of a tire.

In another embodiment, an uncured green tread cap layer is assembled with the tread base layer first to form a tread portion. A cavity is then formed using a die cutting process in the tread portion, wherein the cavity depth is controlled by the depth of the cutting die so to cut through the whole tread cap layer, alternatively cut into a portion of the tread base layer, but not cut through the whole tread base layer.

In another embodiment, a pre-cured tread layer, or PCT, can be subjected to a die cutting process to form cavities through the pre-cured tread layer such that a portion of a tread base layer is exposed to the cavities that can be filled with the UV-curable liquid rubber composition. Alternatively, the pre-cured tread layer can be manufactured with a mold or molding surface having protuberances that form cavities through the pre-cured tread layer to expose an underlying tread base layer.

In another embodiment, a cavity is formed into a cured tread rib portion of an already cured tire using a die cutting process, wherein the depth of the cavity is at least as deep as the depth of the tread cap layer, but less than the depth of the whole tread portion so to contact an underlying electrically conductive portion or layer of the tread portion. The depth of the cavity is controlled by the depth of the cutting die.

The shape of the cavity can be in any shape, such as a cylinder, a cube, a cuboid, a prism, a pyramid or a frustum, and is determined by the shape of the device, for example a cutting die. The average diameter of the cavity is sufficiently large so to fill the cavity easily during manufacturing process, but not too large to interrupt the tire performances. The average diameter of the cavity is in the range of 1 mm to 40 mm, or more preferably 5 mm to 30 mm.

In another embodiment, the tread cap is assembled with the tread base layer first to form a tread portion and then a cavity in the tread cap layer, either existing or formed after assembly, is filled with UV-curable liquid rubber composition. During the manufacturing process, at least the ground-contacting surface of the UV-curable liquid rubber composition in the tread cap layer can be partially cured sufficiently so it can enable the assembly of the tread cap layer and the tread base layer with other tire components without leaking out of the cavity. In another embodiment, the tread cap layer is first filled with UV-curable liquid rubber composition. Both surfaces of the UV-curable liquid rubber composition on top and bottom of the tread cap layer are exposed to UV light to be cured partially so that the UV-curable liquid rubber composition will not flow out of the cavity of the tread cap layer during the assembly of the tires. In both approaches, the tread cap layer and the tread base layer can be in an uncured green state. The tire may be in an uncured green state for manufacturing a new tire. Alternatively, other components of the tire other than the tread cap and tread base layers are in a cured state for tires for retreading purposes.

In another embodiment, the cavity is fully filled, or more preferably overfilled by 1, 5, 10 or 20 volume percent with the UV-curable liquid rubber composition, based on the total volume of the cavity. In an example, overfilling can result in an overflow at the ground contacting surface of the tread cap layer such that the composition expands outward from the cavity diameter and onto the ground contacting surface. Overfilling the cavity is helpful to ensure that the cavity is fully filled after tire curing, for instance, in the case that the UV-curable liquid rubber will shrink upon curing.

The present disclosure is also directed to a method of manufacturing the electrically conductive pathway locally on a tread portion of a tire by using a UV-curable liquid rubber composition after a tire manufacturing process, or on a new or a used tire for repairs to fix electrical conductivity issues. In this instance, the tire cap layer and other components can be all in a cured state. The method includes steps of 1) forming a cavity in a cured tread cap layer locally with the cavity extending from a ground-contacting surface of the tread cap layer to a tread base layer underlying the tread cap layer; 2) filling a UV-curable liquid rubber composition into the cavity, optionally while applying UV-light to the UV-curable liquid rubber composition, or alternatively without applying UV-light; and 3) further applying UV-light to cure the UV-curable liquid rubber composition, or a portion thereof, in the cavity.

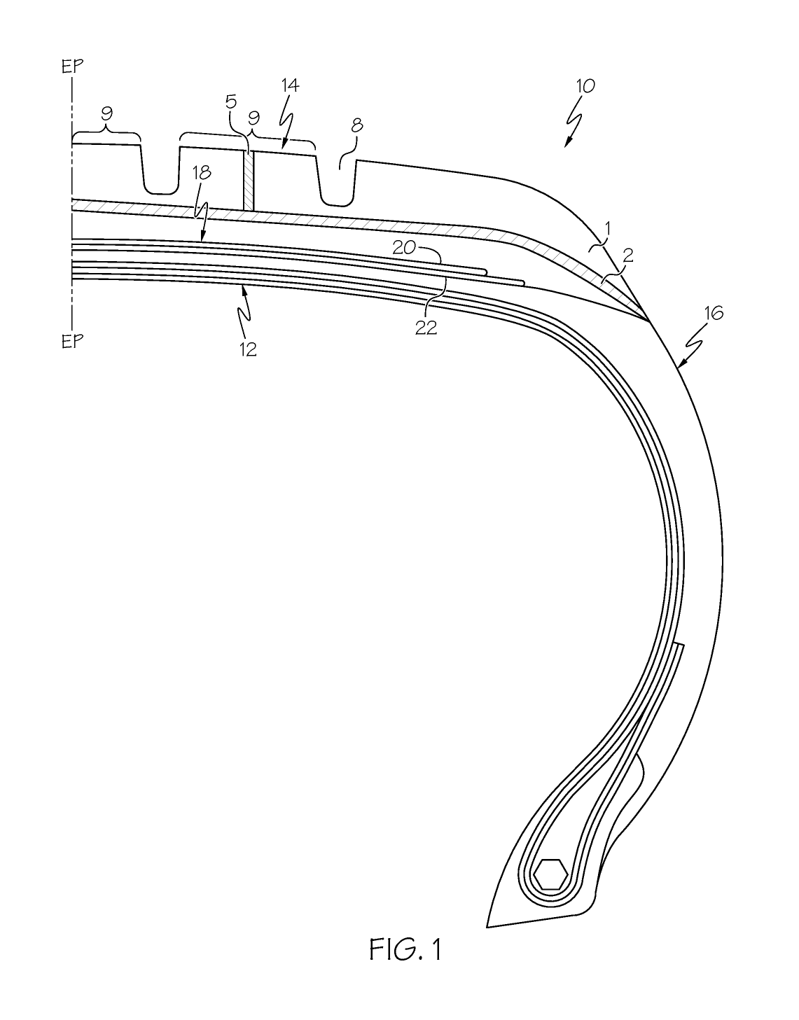

Examples of a pneumatic tire according to the present disclosure are shown in FIGS. 1, 2, 3 and 4. As shown in FIG. 1, the tire 10 can be a vehicle tire, such as radial passenger, truck, off-road and race tires, and can be constructed in a manner conventional in the art. The tire 10 can also include those used for aircraft, industrial vehicles (e.g., vans), heavy vehicles, buses, road transport machinery (e.g., tractors, trailers), off-road vehicles, agricultural machinery or construction machinery, two-wheeled vehicles (e.g., motorcycles), and other transport or handling vehicles. The tire 10 includes a tire carcass 12, a tread portion 14, a sidewall assembly 16 and a belt structure or assembly 18 arranged between the tread portion 14 and tire carcass 12. As shown in FIG. 1, only half of the tire 10 is depicted with the other half being the same as the depicted half.

The belt assembly 18 is positioned circumferentially about the radial outer surface of the tire carcass 12 and beneath the tread portion 14. The belt assembly 18 can provide lateral stiffness across the belt assembly width and reduce lifting of the tread portion 14 from the road surface during rolling. In the embodiment illustrated, the belt assembly 18 can include one or more belt plies 20, 22. The belt plies can include reinforcing components, for example, cords, wires or combination of both made of a non-metal material. In certain embodiments, the reinforcing component may be in different forms, for example, a unitary cord (unit cord), a film (e.g., a strip or band), a multitude of cords that can be twisted together (e.g., a cable) or generally parallel to one another (e.g., a bundle of cords or assembly of fibers).

The reinforcing component, for example cords, can be oriented at any desirable angle with respect to the mid-circumferential center-plane of the tire 10, for instance, in the range of 18 to 26 degrees. In the embodiment that two belt plies are present in the tire, for example, plies 20, 22, the reinforcing components can be oriented in opposite directions from another ply layered above or below. The one or more plies, e.g., 20, 22, can be single cut layers, and preferably do not have folded lateral edges.

The reinforcing component of the belt ply, disposed within the belt skim, can be a nonmetal material. For example, the reinforcing component can include fiberglass, aramid, rayon, polyester, PEN, PET, PVA or combinations thereof.

The belt plies 20, 22 can include a belt skim. The belt skim can surround a portion of a reinforcing component surface or the entire reinforcing component such that the reinforcing component or plurality of components is encased in the belt skim. The belt skim can be in direct contact with the reinforcing component and/or multiple reinforcing components. Alternatively, an intermediate layer or other coating can be arranged between the reinforcing component and/or multiple reinforcing components and the belt skim. The belt skim can be a ply-wide layer.

The tire tread portion 14 may be practiced in the form of the tread on a new tire or practiced in the form of the tread for retreading purposes. The tire tread portion may be further practiced in the form of tread on a new or used tire for purpose of repair to address an electrical conductivity issue related to a tire. The tire tread portion 14 is molded in such a way to create a pattern of tread ribs 9 and grooves 8, wherein the tread ribs 9 form the ground-contacting surface of the tire, and the grooves 8 form voids for the drainage of water and to provide tread groove edges to give the tire traction on road surfaces.

The tire tread portion 14 has a tread cap layer 1 and a tread base layer 2 as depicted in FIGS. 1, 2 and 3. The tread cap layer 1 is the outermost radial component of the tread portion 14 and contains a ground-contacting surface (e.g., rib 9). The tread cap layer 1 overlies and can directly contact the underlying tread base layer 2. The tread cap layer 1 is shown with at least two grooves 8 that extend radially inward, for example, towards the tread base layer 2. As shown, the base of the grooves 8 of the tread cap layer 1 do not contact or extend into the tread base layer 2. The tread cap layer 1 has a tread design having one or more ribs 9 positioned adjacent the grooves 8, wherein the ribs 9 form the side walls of grooves 8. The tread ribs 9 on the tread portion 14 are characterized by circumferentially extending ribs 9 in the tread cap layer 1 that form the ground-contacting surface. Depending on the tread pattern design, typically, the tread portion 14 may have two to nine circumferentially extending ribs, with three to five ribs being preferred. As shown, the tread portion 14 contains at least one, and generally two or more, grooves 8 that define the lateral edges of the accompanying ribs 9. For purposes herein, rib is intended to mean a circumferentially extending blocks or partially extending blocks of rubber on the tread which is defined by the at least one circumferential wide groove and either a second such groove or a lateral edge of the tread cap layer 1.

At least one electrically conductive pathway 5 is formed in the tread cap layer where it contacts ground, such as the near the tread edge or shoulder area next to groove 8, preferably on the tread ribs 9 as shown in FIGS. 1, 2, 3 and 4 at varying locations in the tread ribs 9, and more preferably on the central tread rib 9. As shown, the electrically conductive pathway 5 extends entirely through the tread cap layer 1 from the ground-contacting surface of layer 1 to and contacting the tread base layer 2. The pathway 5 can end at the interface between the layer 1 and 2, or alternatively, extend into layer 2 but preferably not through layer 2. As shown, pathway 5 is encased along its radial direction by layer 5 and has a ground-contacting surface and a conductive surface in contact with layer 2.

FIG. 1 further shows the tread portion 14 having a tread base layer 2 arranged between the tread cap layer 1 and other inner component layers such as an undertread layer or the belt assembly or the belt skim. The tread cap layer 1 and tread base layer 2 can have thicknesses as conventional in the art.

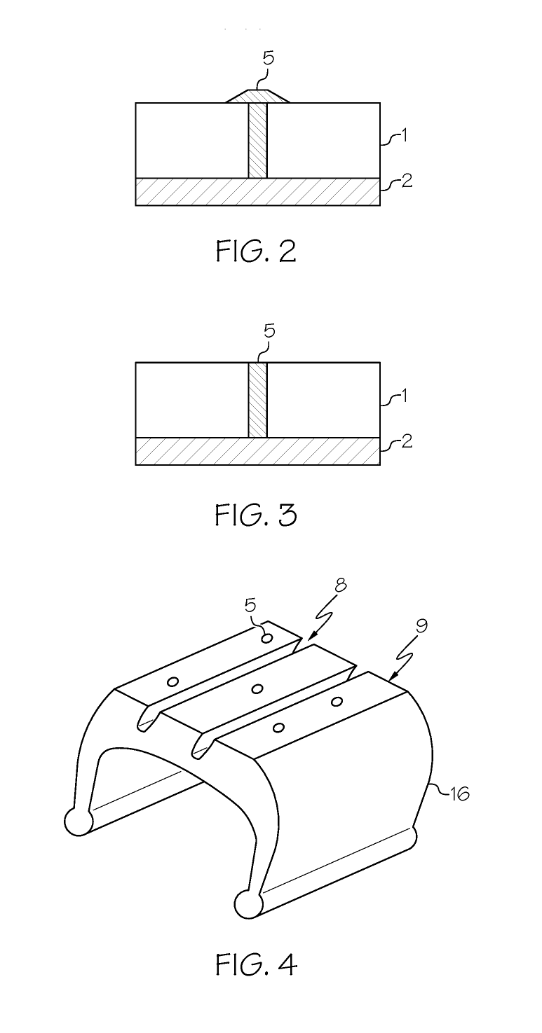

FIG. 2 shows a tread rib 9 on the tread portion 14 having the tread cap layer 1 and tread base layer 2. The electrically conductive pathway 5 is formed on the tread cap layer 1 and is in contact with the tread base layer 2. The electrically conductive pathway may be fully filled or more preferably may be overfilled with the UV-curable liquid rubber composition as depicted in FIG. 2. Overfilling results in pathway 5 contents extending above the ground-contacting surface of layer 1 and circumferentially outward from the pathway 5 diameter onto rib 9. This is to ensure the electrically conductive pathway 5 is fully filled after the tire is fully cured even if the UV-curable liquid rubber will shrink after the cure. FIG. 3 shows the electrically conductive pathway 5 fully filled after the tread portion of a tire is fully cured and finished. The electrically conductive pathway 5 as depicted in FIGS. 1-4 may be in any suitable shape, for example, a circular filled cavity or other shapes, such as triangle, rectangle, or square. The average diameter of the pathway along its length can be from about 1 mm to about 30 mm, preferably from 3 mm to 20 mm. The diameter is preferably substantially constant along its length.

The pneumatic tire has at least one electrically conductive pathway 5 on the tread ribs 9 of the tread portion, or similar tread portion, for example, near the ground-contacting shoulder portion. Alternatively, a tire may have two or more pathways, for example, 3, 4, 5, 6 or more pathways. The electrically conductive pathways may be randomly positioned on any of the ground-contacting parts of the tread portion 14, preferably on the tread ribs 9, more preferably on the central rib 9 of the tread portion to better ensure that the pathway contacts the ground during the full service life of the tires. FIG. 4 shows the potential locations or arrangements of the electrically conductive pathways on the tire ribs 9 of the tire tread portion 14.

The remaining features of the tread depicted in FIGS. 1, 2, 3 and 4 illustrate those features conventional to those skilled in the art.

The present disclosure is further directed to a UV-curable liquid rubber composition, which is UV-curable. Furthermore, the UV-curable liquid rubber composition can be further formulated to be both UV-curable and thermally-curable. The UV-curable liquid rubber composition can have a different composition than other tire components that it contacts, for instance, the compositions that make up the tread portion (e.g., cap and base layers).

In one embodiment, the UV-curable liquid rubber composition includes:
(a) polyfunctionalized diene monomer-containing polymer having a formula: [P][F]ₙ wherein P represents a diene polymer chain; F represents a functional group, n is 2 to about 15, and each F can be the same or different;
(b) optionally a chain extender based upon F or reactive with F;
(c) at least one actinic radiation sensitive photoinitiator;
(d) optionally, a photosensitizer;
(e) a polyfunctional crosslinker reactive with F; and
(f) at least one electrically-conductive filler.

In another embodiment, the UV-curable liquid rubber composition further includes at least one liquid diene rubber having a number average molecular weight Mₙ higher than 1,000 grams per mole, preferably in the range of 5,000 to 300,000 grams per mole, more preferably in the range of 6,000 to 100,000 grams per mole, wherein the liquid diene rubber may be selected from the group consisting of liquid styrene butadiene rubber, liquid butadiene rubber, liquid polyisoprene, liquid isoprene-butadiene rubber, and liquid farnescene.

In another embodiment, the UV-curable liquid rubber composition may include at least one electrically-conductive filler. The electrically-conductive filler may include, but are not limited to, electrically conductive grades of carbon black (e.g., Ketjenblack® EC300J and EC-600JD, BLACK PEARLS® 2000), tire tread reinforcing grades of carbon black, carbon nanotubes, graphene, expanded graphite, metal particles, silica, conductive polymers, doped conductive polymers, and mixtures thereof. Exemplary reinforcing grades of carbon black include: N-110, N-220, N-339, N-330, N-351, N-550, and N-660, and combinations thereof. The requirement for electrical conductivity is different for different types of vehicles. In one example, the electrical conductivity of the UV-curable liquid rubber composition is higher than 1×10⁻⁸ S/cm. In another example, the electrical conductivity of the UV-curable liquid rubber composition is higher than 1×10⁻⁷ S/cm. In another example, the electrical conductivity of the UV-curable liquid rubber composition is higher than 1×10⁶ S/cm, especially for Class-A truck tire applications.

In one embodiment, the electrically-conductive filler in the UV-curable liquid rubber composition is conductive grade of carbon black, Ketjenblack® EC-600JD. The loading level of the conductive carbon black is higher than 5 wt %, which provides sufficient electrical conductivity for dissipating electrostatic charges generated in tires and vehicles. In another embodiment, the electrically-conductive filler in the UV-curable liquid rubber composition is reinforcing grade of carbon black, N-110. The loading level of this reinforcing carbon black is higher than 25 wt % to provide sufficient electrical conductivity for dissipating electrostatic charges generated in tires and vehicles. In another embodiment, the electrically-conductive filler in the UV-curable liquid rubber composition is a carbon nanocomposite, e.g., carbon nanotubes or graphene. The loading level of the carbon nanocomposite is higher than 3 wt % to provide sufficient electrical conductivity for dissipating electrostatic charges generated in tires and vehicles.

In another embodiment, the UV-curable liquid rubber composition contains a thermally-curable sulfur vulcanization package which may contain sulfur, zinc oxide, activators, retarders and at least a primary accelerator. As known to those skilled in the art, depending on the intended use of the sulfur vulcanizable and sulfur vulcanized elastomers, the additives mentioned above are selected and commonly used in conventional amounts. Numerous accelerators are known in the art and include, but are not limited to, diphenyl guanidine (DPG), tetramethylthiuram disulfide (TMTD), 4,4′-dithiodimorpholine (DTDM), tetrabutylthiuram disulfide (TBTD), benzothiazyl disulfide (MBTS), 2-(morpholinothio)benzothiazole (MBS), N-tert-butyl-2-benzothiazole sulfonamide (TBBS), N-cyclohexyl-2-benzothiazole sulfonamide (CBS), and mixtures thereof.

In another embodiment, the UV-curable liquid rubber composition may further contain a thermally vulcanizable organic peroxide package. The thermally vulcanizable organic peroxide package may include one or more organic peroxides and coagents. A number of organic peroxides are known in the art and include, but are not limited to, dicumyl peroxide and α,α′-bis(t-butylperoxy)diisopropylbenzene. The coagents may include, but are not limited to, octyl acrylate, decyl acrylate, 1,6-hexanediol diacrylate, zinc diacrylate, zinc dimethacrylate, trimethylolpropane triacrylate, pentaerythritol tetraacrylate, dipentaerythritol pentaacrylate, triallyl cyanurate, triallyl isocyanurate, and high vinyl polybutadiene.

As discussed above, the UV-curable liquid rubber composition can include a polyfunctionalized diene monomer-containing polymer which includes a diene polymer chain [P]. In certain embodiments, the actinic radiation curable polymeric mixture includes one type of polyfunctionalized diene monomer-containing polymer and in other embodiments, the mixture includes more than one type of polyfunctionalized diene monomer-containing polymer. Polyfunctionalized diene monomer-containing polymers can be categorized into different types based upon one or more of: molecular weight, monomer type(s), relative amount of monomer(s), types of functional group(s) (e.g., free radical polymerizable or cationic polymerizable), identity of functional group(s) (as discussed in more detail below), and amount of functional group(s). In certain embodiments, the polyfunctionalized diene monomer-containing polymer(s) can be referred to as a pre-polymer since they will react with each other and with a chain extender (when a chain extender is present) to form a higher molecular weight polymer. The diene polymer chain includes (is based upon) at least one diene monomer. A diene monomer is a monomer having two carbon-carbon double bonds. Various diene monomers exist and are generally suitable for use in preparing the diene polymer chain of the polyfunctionalized diene monomer-containing polymer. In certain embodiments according to the first-fifth embodiments disclosed herein, the diene polymer chain of the polyfunctionalized diene monomer-containing polymer includes monomers selected from at least one of: acyclic and cyclic dienes having 3 to about 15 carbon atoms. In certain embodiments according to the first-fifth embodiments disclosed herein, the diene polymer chain of the polyfunctionalized diene monomer-containing polymer includes monomers selected from at least one of: 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene, 2,4-hexadiene, 1,3-cyclopentadiene, 1,3-cyclohexadiene, 1,3-cycloheptadiene, and 1,3-cyclooctadiene, farnescene, and substituted derivatives of each of the foregoing. In certain embodiments, the diene polymer chain of the polyfunctionalized diene monomer-containing polymer includes 1,3-butadiene monomer, isoprene monomer, or a combination thereof. In certain embodiments, the diene polymer chain of the polyfunctionalized diene-monomer-containing polymer further includes at least one vinyl aromatic monomer. Non-limiting examples of suitable vinyl aromatic monomers include, but are not limited to, styrene, α-methyl styrene, p-methylstyrene, o-methylstyrene, p-butylstyrene, vinylnaphthalene, p-tertbutylstyrene, vinyl catechol-based, and combinations thereof. In certain embodiments, the diene polymer chain of the polyfunctionalized diene monomer-containing polymer includes a combination of 1,3-butadiene monomer and styrene monomer.

As discussed above, the term “polyfunctionalized” is used herein to refer to more than one functionalization and includes polymers that have been di-functionalized, tri-functionalized, etc. Generally, functionalization of a polymer may occur at one or both ends of a polymer chain, along the backbone of the polymer chain, and combinations thereof. Generally, each F functional group present in the polyfunctionalized diene monomer-containing polymer may be same or different. In certain embodiments according to the first-fifth embodiments disclosed herein, the polyfunctionalized diene monomer-containing polymer includes a di-functionalized polymer having an F functional group at each terminal end of the polymer chain; each F functional group may be the same or different. In certain embodiments according to the first-fifth embodiments disclosed herein, the polyfunctionalized diene monomer-containing polymer includes a di-functionalized polymer having a F functional group at one terminal end of the polymer chain and at least one additional F functional group along the backbone of the polymer chain; each F functional group may be the same or different. In certain embodiments according to the first-fifth embodiments disclosed herein, the polyfunctionalized diene monomer-containing polymer includes a functionalized polymer having at least three F functional groups, with one at each terminal end of the polymer chain, and at least one along the backbone of the polymer chain; each F functional group may be the same or different.

Various polyfunctionalized diene monomer-containing polymers are commercially available and may be suitable for use in various embodiments of the first-fifth embodiments disclosed herein. Non-limiting examples of these include, but are not limited to, Sartomer CN307 polybutadiene dimethacrylate, Sartomer CN301 polybutadiene dimethacrylate and Sartomer CN303 hydrophobic acrylate ester, all available from Sartomer Americas (Exton, Pa.); Ricacryl® 3500 methacrylated polybutadiene, Ricacryl® 3801 methacrylated polybutadiene, Ricacryl® 3100 methacrylated polybutadiene, all available from Cray Valley USA LLC (Exton, Pa.); BAC-45 polybutadiene diacrylate and BAC-15 polybutadiene diacrylate, available from San Esters Corp. (New York, N.Y.); Kuraray UC-102 methacrylated polyisoprene and UC-203 methacrylated polyisoprene, available from Kuraray America Inc. (Pasadena, Tex.); Poly Bd® 600E epoxidized polybutadiene and Poly Bd® 605E polybutadiene, available from Cray Valley USA LLC (Exton, Pa.). Methods for preparing polyfunctionalized diene monomer-containing polymers are well-known to those of skill in the art and include those using functional initiators, functional terminators and reactions of diol terminated dienes with various functional acid chlorides or with carboxylic acids (through a dehydration reaction). Other methods include the reaction of an oxidant and a carboxylic acid to form a peracid for adding an epoxy group.

In certain embodiments, the diene polymer chain of the polyfunctionalized diene monomer-containing polymer includes: polybutadiene, styrene-butadiene copolymer, polyisoprene, ethylene-propylene-diene rubber (EPDM), styrene-isoprene rubber, or butyl rubber (halogenated or non-halogenated).

The molecular weight of the polyfunctionalized diene monomer-containing polymer may vary widely depending upon various factors, including, but not limited to the amount and type of chain extender (if any) that is utilized in the actinic radiation curable polymeric mixture. Generally, higher molecular weight polymers will lead to better properties in the cured article or product, but will also lead to higher viscosities in the overall actinic radiation curable polymeric mixture. Thus, preferred polyfunctionalized diene monomer-containing polymers for use in the mixture will balance molecular weight with its effect on viscosity. In certain embodiments, the polyfunctionalized diene monomer-containing polymer has a Mn of about 3,000 to about 135,000 grams/mole (polystyrene standard). In certain embodiments, the polyfunctionalized diene monomer-containing polymer has a Mn of 3,000 to 135,000 grams/mole (polystyrene standard); including about 5,000 to about 100,000 grams/mole (polystyrene standard); 5,000 to 100,000 grams/mole (polystyrene standard); about 10,000 to about 75,000 grams/mole (polystyrene standard); and 10,000 to 75,000 grams/mole (polystyrene standard). The number average molecular weights (Me) values that are discussed herein for the polyfunctionalized diene monomer-containing polymer include the weight contributed by the functional groups (F).

In certain embodiments, the cured elastomeric mixture includes crosslinked polyfunctionalized diene monomer-containing polymer has a Mc (molecular weight between crosslinks) of about 500 to about 150,000 grams/mole, including 500 to 150,000 grams/mole (e.g., 1000, 2500, 5000, 10000, 20000, 25000, 30000, 40000, 50000, 60000, 70000, 80000, 90000, 100000, 110000, 115000, 120000, 130000, 140000 or 150000). The crosslinked molecular weight (Mc) values that are discussed herein for the polyfunctionalized diene monomer-containing polymer include the weight contributed by the functional groups (F). Mc can be determined in accordance with previously published procedures such as those disclosed in Hergenrother, J., Appl. Polym. Sci., v. 32, pp. 3039 (1986), herein incorporated by reference in its entirety.

In certain embodiments, the molecular weight of the crosslinked polyfunctionalized diene monomer-containing polymer of the cured elastomeric mixture can be quantified in terms of Mᵣ or molecular weight between chain restrictions. In certain embodiments, the cured elastomeric mixture includes crosslinked polyfunctionalized diene monomer-containing polymer has a Mc (molecular weight between crosslinks) of about 500 to about 150,000 grams/mole, including 500 to 150,000 grams/mole (e.g., 1000, 2500, 5000, 10000, 20000, 25000, 30000, 40000, 50000, 60000, 70000, 80000, 90000, 100000, 110000, 115000, 120000, 130000, 140000 or 150000). The crosslinked molecular weight (Mc) values that are discussed herein for the polyfunctionalized diene monomer-containing polymer include the weight contributed by the functional groups (F). Generally Mᵣ can be determined according to the procedure described in U.S. Patent Application Publication No. 2012/0174661, herein incorporated by reference in its entirely. More specifically, Mᵣ can be determined according to the following equation:

$${M}_{r} = \frac{ρ RT ( Λ - {Λ}^{- 2} )}{σ}$$

where ρ is the compound density, σ is stress, R is the gas constant, T is temperature, A is 1+Xϵ where X is the strain amplification factor from the Guth-Gold equation and the strain (ϵ) is (1−lₛₑₜ)/lₛₑₜ where l is the specimen length at a point on the retraction curve and lₛₑₜ is the specimen length after retraction to zero stress. A TR or tensile retraction test set consists of at least two tensile retraction tests, each to a progressively higher target extension ratio, Λmax, followed immediately by a retraction to a zero stress. Each tensile pull and subsequent retraction are performed at the same testing rate such that a series of extension and retraction curve pairs are obtained. During each retraction, the stress, σ, is measured as a function of extension ratio, Λ, defining the tensile retraction curve. Testing may be performed in accordance with the procedures outlined in Hergenrother, J., Appl. Polym. Sci., v. 32, pp. 3039 (1986), herein incorporated by reference in its entirety.

When determining Mᵣ for compounds containing rigid fillers, the enhancement of modulus due to rigid particles should be taken into account in a fashion similar to that of Harwood and Payne, J. Appl. Polym. Sci., v. 10, pp. 315 (1966) and Harwood, Mullins and Payne, J. Appl. Polym. Sci, v. 9, pp. 3011 (1965), both of which are herein incorporated by reference in their entirety. When a filled compound is first stretched in tension to the same stress as its corresponding gum compound (e.g., non-filled compound), subsequent retraction and extension curves are generally very similar to those of the gum compounds when stress is graphed as a function of normalized strain. Normalized strain is defined as the strain at any point on the subsequent extension or retraction curves divided by the maximum strain of the initial extension. For retraction curves in particular, and for maximum strains of natural rubber gum compounds up to and including near breaking strain, this could be applied to a number of filled compounds. The result can be interpreted as evidence of strain amplification of the polymer matrix by the filler, where the average strain the polymer matrix of a filled compound is the same as that in the corresponding gum (non-filled) compound, when the filled and gum compounds are compared at the same stress. Strain amplification X can be determined by the Guth-Gold equation as discussed in Mullins et al., J. Appl. Polym. Sci., vol. 9, pp. 2993 (1965) and Guth et al., Phys. Rev. v. 53, pp. 322 (1938), both of which are herein incorporated by reference in their entirety. After correction of A for filler level, neo-Hookean rubber elasticity theory (Shen, Science & Technology of Rubber, Academic Press, New York, 1978, pp. 162-165, herein incorporated by reference) may be applied to an internal segment of the retraction curve from which a molecular weight between chain restrictions of all types, Mᵣ can be calculated according to the above equation. Extension of the same rubber specimen to successively higher Λmax provides Mᵣ as a function of Λmax.

Tensile retraction testing can be measured using a special ribbed TR mold to prevent slippage when stretched in tension between clamps of an Instron 1122 tester controlled by a computer (for testing, data acquisition and calculations), as described in Hergenrother, J., Appl. Polym. Sci., v. 32, pp. 3039 (1986). Specimens for testing may be nominally 12 mm wide by 50 mm long by 1.8 mm thick. Mᵣ can be calculated at each of 25 (σ, Λ) pairs, collected from about the middle one-third of the particular retraction curve. Mᵣ values as disclosed herein may be the average of the 25 calculated values. In order to reduce test time, elongations to successively higher Λmax can be carried out at successively higher speeds of the Instron crosshead motion. A master TR curve can be obtained by shifting the different test speeds to a standardized testing rate of 5%/minute. High strain (greater than about 40% to 80% elongation) region of the smooth curve obtained may be fitted by a linear equation of the form of M=S(Λmax−1)+Mc. The fit to strain region at less than 80% elongation may deviate steadily from the Mᵣ line as strains are progressively reduced. The logarithim of such difference between the calculated and observed νe can be plotted versus the lower level of strain to give a linear fit to Δνe as a function of (Λmax−1). The antilog of the reciprocal of the intercept, m, can be denoted as B (expressed in kg/mole) and relates to the micro-dispersion of the filler. See, U.S. Pat. No. 6,384,117, herein incorporated by reference in its entirety. In a similar fashion, the lowest strain deviation can be treated to give a plot of ΔΔνe as a function of (Λmax−1). The antilog of the reciprocal of the intercept for the process that occurs at strains of less than 6% elongation can be denoted as y (expressed in kg/mole). These three equations, each with a slope and intercept, can be used to fit the various strain regions of the TR curve can be summed to provide a single master equation that empirically describes the Mᵣ response over the entire range of testing. Experimental constants of the new master equation can be adjusted using ExcelSolver® to obtain the best possible fit of the predicted values to the experimental values obtained by TR. Fitting criteria consisting of a slope and an intercept can be determined when the experimental and curve fit values of Mᵣ are compared. The composite equation can allow the transition between each fitted linear region to be independent of the choice of the experimental strains measured and the small mathematical adjusting of the strain range can allow a more precise linear fit of the data to be made.

As discussed above, F represents a functional group associated with the polyfunctionalized diene monomer-containing polymer. Various types of functional groups F may be suitable for use in certain embodiments of the first-fifth embodiments disclosed herein. In certain embodiments, these functional groups F can be described as either free radical polymerizable or cationic polymerizable, which is a general description of how the groups react upon exposure to actinic radiation (light) to result in cross-linking or curing. Generally, functional groups that improve curability (cross-linking) by actinic radiation are useful as the functional group F.

In certain embodiments, the F functional group of the polyfunctionalized diene monomer-containing polymer includes a free radical polymerizable functionalizing group. In certain embodiments, the F functional group of the polyfunctionalized diene monomer-containing polymer includes a cationic polymerizable functionalizing group. In certain embodiments, the F functional group of the polyfunctionalized diene monomer-containing polymer includes a combination of cationic polymerizable and free radical polymerizable functional groups either on the same diene polymer chain or on separate diene polymer chains. Generally, functional groups that are free radical polymerizable have the advantage of reacting faster than cationic polymerizable functionalizing groups, but the disadvantage is being prone to inhibition by oxygen exposure. Generally, functional groups that are cationic polymerizable have the advantage of being resistant to oxygen exposure (i.e., they are not inhibited), but have the disadvantages of being prone to inhibition by water exposure and having a generally slower rate of reaction. The combination of cationic polymerizable and free radical polymerizable functional groups can be advantageous as providing the advantages of each type and minimizing the disadvantages of each alone; an additional advantage of such a combination is to allow for a double network system wherein a crosslink of a first type occurs at a first wavelength and a crosslink of a second type occurs at a second wavelength or a single wavelength is used to activate both types of photoinitators which will create a double network.

In certain embodiments, each functional group F in the polyfunctionalized diene monomer-containing polymer includes at least one of: acrylate, methacrylate, cyanoacrylate, epoxide, aziridine, and thioepoxide. In certain embodiments, each functional group F in the polyfunctionalized diene monomer-containing polymer includes an acrylate or methacrylate. Suitable acrylates or methacrylates may be linear, branched, cyclic, or aromatic. As used herein, the term acrylate should be understood to include both acrylic acid and esters thereof. Similarly, the term methacrylate should be understood to include both methacrylic acid and esters thereof. Various types of acrylates and methacrylates are commonly used and may be suitable for use as the functional group F. In certain embodiments of the first-fifth embodiments disclosed herein, the function group F includes at least one of: acrylic acid, methacrylic acid, ethyl (meth)acrylate, methyl (meth)acrylate, butyl (meth)acrylate, isobutyl (meth)acrylate, cyclobutyl (meth)acrylate, (cyano)acrylate, 2-ethylhexyl(meth)acrylate, isostearyl (meth)acrylate, isobornyl (meth)acrylate, propyl (meth)acrylate, isopropyl (meth)acrylate, cyclopropyl (meth)acrylate, pentyl (meth)acrylate, isopentyl (meth)acrylate, cyclopentyl (meth)acrylate, hexyl (meth)acrylate, isohexyl (meth)acrylate, cyclohexyl (meth)acrylate, heptyl (meth)acrylate, isoheptyl (meth)acrylate, cycloheptyl (meth)acrylate, octyl (meth)acrylate, cyclooctyl (meth)acrylate, nonyl (meth)acrylate, isononyl (meth)acrylate, cyclononyl (meth)acrylate, decyl (meth)acrylate, isodecyl (meth)acrylate, cyclodecyl (meth)acrylate, undecyl (meth)acrylate, isoundecyl (meth)acrylate, cycloundecyl (meth)acrylate, lauryl (meth)acrylate, tridecyl (meth)acrylate, isotridecyl (meth)acrylate, cyclotridecyl (meth)acrylate, tetradecyl (meth)acrylate, isotetradecyl (meth)acrylate, cyclotetradecyl (meth)acrylate, pentadecyl (meth)acrylate), isopentadecyl (meth)acrylate, cyclopentadecyl (meth)acrylate, and combinations thereof. In certain embodiments, each functional group F in the polyfunctionalized diene monomer-containing polymer includes an epoxide or a thioepoxide. In certain embodiments, each functional group F in the polyfunctionalized diene monomer-containing polymer includes an aziridine, which generally can be considered to be a compound containing the aziridine functional group (a 3-membered heterocyclic group with one amine (—NR—), where R is H, CH₃, and two methylenes (—CH₂—).

In certain embodiments, the chain extender may be chosen based upon compound having a moiety that is reactive with the F functional group of the polyfunctionalized diene monomer-containing polymer.

In certain embodiments, the chain extender includes one or more additional functional groups F1 along the backbone of the polymer. Such functional groups may be chosen based upon their contribution to desirable properties in the cured polymeric mixture, the cured elastomeric 3-dimensional article or final product. As a non-limiting example, the F1 functional groups may be selected to interact with one or more fillers such as silica filler, i.e., F1 includes a silica-reactive functional group. Thus, in certain embodiments the polyfunctionalized diene monomer-containing polymer includes at least one F1 silica-reactive functional group along its backbone. Non-limiting examples of silica-reactive functional groups include nitrogen-containing functional groups, silicon-containing functional groups, oxygen- or sulfur-containing functional groups, and metal-containing functional groups. Another specific example of a F1 functional group includes phosphorous-containing functional groups.

Non-limiting examples of nitrogen-containing functional groups that can be utilized as a F1 silica-reactive functional group along the backbone of the polyfunctionalized diene monomer-containing polymer in certain embodiments include, but are not limited to, any of a substituted or unsubstituted amino group, an amide residue, an isocyanate group, an imidazolyl group, an indolyl group, a nitrile group, a pyridyl group, and a ketimine group. The foregoing substituted or unsubstituted amino group should be understood to include a primary alkylamine, a secondary alkylamine, or a cyclic amine, and an amino group derived from a substituted or unsubstituted imine. In certain embodiments of the first-third embodiments, the polyfunctionalized diene monomer-containing polymer includes at least one F1 functional group along its backbone selected from the foregoing list of nitrogen-containing functional groups.

Non-limiting examples of silicon-containing functional groups that can be utilized as a F1 silica-reactive functional group along the backbone of the polyfunctionalized diene monomer-containing polymer in certain embodiments include, but are not limited to, an organic silyl or siloxy group, and more precisely, the functional group may be selected from an alkoxysilyl group, an alkylhalosilyl group, a siloxy group, an alkylaminosilyl group, and an alkoxyhalosilyl group. Suitable silicon-containing functional groups for use in functionalizing diene-based elastomer also include those disclosed in U.S. Pat. No. 6,369,167, the entire disclosure of which is herein incorporated by reference. In certain embodiments of the first-third embodiments, the polyfunctionalized diene monomer-containing polymer includes at least one F1 functional group along its backbone selected from the foregoing list of silicon-containing functional groups.

Non-limiting examples of oxygen- or sulfur-containing functional groups that can be utilized as a F1 silica-reactive functional group along the backbone of the polyfunctionalized diene monomer-containing polymer in certain embodiments include, but are not limited to, a hydroxyl group, a carboxyl group, an epoxy group, a glycidoxy group, a diglycidylamino group, a cyclic dithiane-derived functional group, an ester group, an aldehyde group, an alkoxy group, a ketone group, a thiocarboxyl group, a thioepoxy group, a thioglycidoxy group, a thiodiglycidylamino group, a thioester group, a thioaldehyde group, a thioalkoxy group, and a thioketone group. In certain embodiments, the foregoing alkoxy group may be an alcohol-derived alkoxy group derived from a benzophenone. In certain embodiments of the first-third embodiments, the polyfunctionalized diene monomer-containing polymer includes at least one F1 functional group along its backbone selected from the foregoing list of oxygen- or sulfur-containing functional groups.

Non-limiting examples of phosphorous-containing functional groups that can be utilized as a F1 functional group along the backbone of the polyfunctionalized diene monomer-containing polymer in certain embodiments include, but are not limited to, organophosphorous compounds (i.e., compounds containing carbon-phosphorous bond(s)) as well as phosphate esters and amides and phosphonates. Non-limiting examples of organophosphorous compounds include phosphines including alkyl phosphines and aryl phosphines. In certain embodiments of the first-third embodiments, the polyfunctionalized diene monomer-containing polymer includes at least one F1 functional group along its backbone selected from the foregoing list of phosphorous-containing functional groups.

As discussed above, the actinic radiation curable polymeric mixture optionally includes a chain extender based upon F or reactive with F. In other words, in certain embodiments the mixture includes a chain extender, but it is not considered to be essential in all embodiments. Generally, the chain extender is a hydrocarbon or hydrocarbon derivative that is monofunctionalized with a functional group that reacts with a functional end group of the dienepolymer chain of the polyfunctionalized diene monomer-containing polymer and is used to increase the molecular weight of the polyfunctionalized diene monomer-containing polymer (by bonding to one of the F groups of the polymer). Preferably, the chain extender lowers the viscosity of the overall actinic radiation curable polymeric mixture and also acts to increase the molecular weight of the polyfunctionalized diene monomer-containing polymer between crosslinks. In certain embodiments, the chain extender also increases the elongation at break of the cured elastomeric/polymeric mixture that results from actinic radiation curing the polymeric mixture.

In certain embodiments when the chain extender is present, it includes a compound that is based upon F. In other words, such a chain extender compound includes an F group. In certain embodiments when the chain extender is present, it includes a compound that is based upon F or a compound that is reactive with F. By reactive with F is meant a compound containing a moiety that will bond with the F group of the polyfunctionalized diene monomer-containing polymer.

As discussed above, in those embodiments where the chain extender is present, it may include a hydrocarbon or hydrocarbon derivative with monofunctionality selected from various functional groups either based on F or reactive with F. In certain embodiments when the chain extender is present, it is selected so that the Tg of the chain-extended polyfunctionalized diene monomer-containing polymer is less than about 25° C., including about −65° C. to about 10° C. Preferably, the chain extender is selected so that the Tg of the extended polyfunctionalized diene monomer-containing polymer even after crosslinking is less than about 25° C., including about −65° C. to about 10° C. In certain embodiments when the chain extender is present, it includes a compound that has a Mw of about 70 to about 1000 grams/mole, including about 72 to about 500 grams/mole.

In certain embodiments of the first-fifth embodiments, when the chain extender is present, it includes at least one alkyl (meth)acrylate monomer. In certain such embodiments, the alky (meth)acrylate monomer is composed of an alkyl chain selected from C2 to about C18 and having a reactive meth(acrylate) head group, termed alkyl functionalized (meth)acrylates; alkyl (meth)acrylate monomers having larger alkyl groups may have a thermal transition, Tm, that is higher than desired. By utilizing as a chain extender a compound/monomer that contains only one functional group (e.g., a (meth)acrylate) it is possible to increase the molecular weight between crosslinks, while reducing the viscosity.

In certain embodiments when the F group of the polyfunctionalized diene monomer-containing polymer includes an acrylate or methacrylate, the chain extender includes at least one alkyl (meth)acrylate monomer. In certain such embodiments, the alky (meth)acrylate monomer is at least one monomer selected from C2 to about C18 alkyl functionalized (meth)acrylates; alkyl (meth)acrylate monomers having larger alkyl groups may have a Tg that is higher than desired and may unduly increase the Tg of the overall actinic radiation curable polymeric mixture.

In certain embodiments, the total amount of polyfunctionalized diene monomer-containing polymer and chain extender can be considered to be 100 parts by weight; in certain such embodiments, the polyfunctionalized diene monomer-containing polymer is present in an amount of 1-100 parts by weight and the chain extender is present in an amount of 0-99 parts by weight. In other words, the chain extender is optional in certain embodiments. Generally, the relative amounts of polyfunctionalized diene monomer-containing polymer and chain extender can vary greatly because, as discussed above, upon exposure to actinic radiation the chain extender adds to the polymer and increases its molecular weight. As a non-limiting example, when the Mn of the polyfunctionalized diene monomer-containing polymer is relatively low (e.g., about 3,000 grams/mole, polystyrene standard), and the Mw of the chain extender is relatively high (e.g., about 1000 grams/mole), the total amount of polyfunctionalized diene monomer-containing polymer and chain extender can include relatively less polymer than chain extender. In certain embodiments, the polyfunctionalized diene monomer-containing polymer is present in an amount of 1-90 parts by weight and the chain extender is present in an amount of 10-99 parts by weight, including 1-80 parts by weight polyfunctionalized diene monomer-containing polymer and the chain extender is present in an amount of 20-99 parts by weight, 1-70 parts by weight polyfunctionalized diene monomer-containing polymer and the chain extender is present in an amount of 30-99 parts by weight, 1-60 parts by weight polyfunctionalized diene monomer-containing polymer and the chain extender is present in an amount of 40-99 parts by weight, 1-50 parts by weight polyfunctionalized diene monomer-containing polymer and the chain extender is present in an amount of 50-99 parts by weight, 1-40 parts by weight polyfunctionalized diene monomer-containing polymer and the chain extender is present in an amount of 60-99 parts by weight, 1-30 parts by weight polyfunctionalized diene monomer-containing polymer and the chain extender is present in an amount of 70-99 parts by weight, 1-20 parts by weight polyfunctionalized diene monomer-containing polymer and the chain extender is present in an amount of 80-99 parts by weight, 1-10 parts by weight polyfunctionalized diene monomer-containing polymer and the chain extender is present in an amount of 10-99 parts by weight. In certain embodiments, the polyfunctionalized diene monomer-containing polymer is present in an amount of 10-99 parts by weight and the chain extender is present in an amount of 1-90 parts by weight, including 20-99 parts by weight polyfunctionalized diene monomer-containing polymer and the chain extender is present in an amount of 1-80 parts by weight, 30-99 parts by weight polyfunctionalized diene monomer-containing polymer and the chain extender is present in an amount of 1-70 parts by weight, 40-99 parts by weight polyfunctionalized diene monomer-containing polymer and the chain extender is present in an amount of 1-60 parts by weight, 50-99 parts by weight polyfunctionalized diene monomer-containing polymer and the chain extender is present in an amount of 1-50 parts by weight, 60-99 parts by weight polyfunctionalized diene monomer-containing polymer and the chain extender is present in an amount of 1-40 parts by weight, 70-99 parts by weight polyfunctionalized diene monomer-containing polymer and the chain extender is present in an amount of 1-30 parts by weight, 80-99 parts by weight polyfunctionalized diene monomer-containing polymer and the chain extender is present in an amount of 1-20 parts by weight, 90-99 parts by weight polyfunctionalized diene monomer-containing polymer and the chain extender is present in an amount of 1-10 parts by weight.

In certain embodiments, when the F groups of the polyfunctionalized diene monomer-containing polymer include (meth)acrylate and the F groups of the chain extender include an alkyl (meth)acrylate, the relative amounts of polymer and chain extender are about 50 parts and 50 parts, respectively, including about 40 to about 60 parts polymer and about 60 to about 40 parts chain extender, 40 to 60 parts polymer and 60 to 40 parts chain extender about 45 to about 60 parts polymer and about 55 to about 40 parts chain extender 45 to 60 parts polymer and 55 to 40 parts chain extender about 50 to about 60 parts polymer and about 40 to about 50 parts chain extender; 50 to 60 parts polymer and 40 to 50 parts chain extender about 55 to about 60 parts polymer and about 40 to about 45 parts chain extender; and 55 to 60 parts polymer and 40 to 45 parts chain extender.

In certain embodiments, in addition to being monofunctionalized with at least one F group or a functional group reactive with F, the chain extender is further functionalized with at least one functional group F2 that is molecular oxygen reactive. Non-limiting examples of suitable F2 groups include various amines, including, but not limited to, tertiary amines, secondary amines, and primary amines; thiols; silanes; phosphites, tin-containing compounds, lead containing compounds, and germanium-containing compounds. Incorporating at least one molecular oxygen reactive F2 functional group into the chain extender reduces the amount of undesirable oxidation that may otherwise occur from either solubilized oxygen within the actinic radiation curable polymeric mixture or atmospheric oxygen. Without being bound by theory, a functional group F2 that is molecular oxygen reactive can react with any peroxy radicals that are generated (e.g., from the reaction of a free radical with molecular oxygen) to create a new initiator by hydrogen absorption; this reaction avoid or minimizes the undesirable reaction between a peroxy radical and an initiator (which will yield a non-productive product and consume the initiator). The amount of F2 functionalization on the chain extender may vary. In certain embodiments, the chain extender is about 10 to 100% functionalized with at least one functional group F2 that is molecular oxygen reactive, including 10 to 100% functionalized, about 20 to 100% functionalized, 20 to 100% functionalized, about 30 to 100% functionalized, 30 to 100% functionalized, about 40 to 100% functionalized, 40 to 100% functionalized, about 50 to 100% functionalized, 50 to 100% functionalized, about 10 to about 90% functionalized, 10 to 90% functionalized, about 10 to about 80% functionalized, 10 to 80% functionalized, about 10 to about 70% functionalized, 10 to 70% functionalized, about 10 to about 60% functionalized, 10 to 60% functionalized, about 10 to about 50% functionalized, and 10 to 50% functionalized. In other embodiments, in addition to including at least one functional group F2 that is molecular oxygen reactive or as an alternative to including at least one functional group F2 that is molecular oxygen reactive, a separate molecular oxygen reactive ingredient can be utilized in the actinic radiation curable polymeric mixture. Generally, this separate ingredient includes a hydrocarbon or hydrocarbon derivative functionalized with at least one of the functional groups discussed above for F2.

As discussed above, the actinic radiation curable polymeric mixture includes at least one actinic radiation sensitive photoinitiator. In certain embodiments, the polymeric mixture includes two, three, or more one actinic radiation sensitive photoinitiators. Generally, the purpose of the photoinitiator is to absorb actinic radiation (light) and generate free radicals or a Lewis acid that will react with the functional groups of the polymer resulting in polymerization. Two types of actinic radiation sensitive photoinitators exist: free radical and cationic. Free radical photoinitiators can themselves be separated into two categories, those that undergo cleavage upon irradiation to generate two free radicals (e.g., benzoins, benzoin ethers, and alpha-hydroxy ketones) and those that form an excited state upon irradiation and then abstract an atom or electron from a donor molecule which itself then acts as the initiating species for polymerization (e.g., benzophenones). In certain embodiments of the first-fifth embodiments disclosed herein, the photoinitiator includes at least one free radical photoinitiator. In certain embodiments of the first-fifth embodiments disclosed herein, the photoinitiator includes at least one cationic photoinitiator. In certain embodiments of the first-fifth embodiments disclosed herein, the photoinitiator includes a combination of at least one free radical photoinitiator and at least one cationic photoinitiator.

When a photoinitiator is utilized, various photoinitiators are suitable for use in the actinic radiation curable polymeric mixtures. In certain embodiments of the first-fifth embodiments disclosed herein, the photoinitiator includes at least one of: a benzoin, an aryl ketone, an alpha-amino ketone, a mono- or bis(acyl)phosphine oxide, a benzoin alkyl ether, a benzil ketal, a phenylglyoxalic ester or derivatives thereof, an oxime ester, a per-ester, a ketosulfone, a phenylglyoxylate, a borate, and a metallocene. In certain embodiments of the first-fifth embodiments disclosed herein, the photoinitiator includes at least one of: a benzophenone, an aromatic α-hydroxyketone, a benzilketal, an aromatic α-aminoketone, a phenylglyoxalic acid ester, a mono-acylphosphinoxide, a bis-acylphosphinoxide, and a tris-acylphosphinoxide. In certain embodiments of the first-fifth embodiments disclosed herein, the photoinitiator is selected from benzophenone, benzildimethylketal, 1-hydroxy-cyclohexyl-phenyl-ketone, 1-[4-(2-hydroxyethoxy)-phenyl]-2-hydroxy-2-methyl-1-propan-1one, 2-hydroxy-1-{4-[4-(2-hydroxy-2-methyl-propionyl)-benzyl]-phenyl}-2-methyl-propan-1-one, (4-methylthiobenzoyl)-1-methyl-1-morpholinoethane, (4-morpholinobenzoyl)-1-benzyl-1-dimethylaminopropane, (4-morpholinobenzoyl)-1-(4-methylbenzyl)-1-dimethylaminopropane, (2,4,6-trimethylbenzoyl)diphenylphosphine oxide, bis(2,6-dimethoxy-benzoyl)-(2,4,4-trimethyl-pentyl)phosphine oxide, bis(2,4,6-trimethylbenzoyl)-phenylphosphine oxide and 2-hydroxy-1-{1-[4-(2-hydroxy-2-methyl-propionyl)-phenyl]-1,3,3-trimethyl-indan-5-yl}-2-methyl-propan-1-one, 1,2-octanedione, 1-[4-(phenylthio)phenyl]-,2-(O-benzyloxime), oligo[2-hydroxy-2-methyl-1-[4-methylvinyl]phenyl]propanone, 2-hydroxy-2-methyl-1-phenyl propan-1-one, and combinations thereof.

The amount of actinic radiation sensitive photoinitiator(s) utilized can vary. In certain embodiments of the first-fifth embodiments disclosed herein, when the photoinitiator is present, the actinic radiation curable polymeric mixture includes about 1 to about 10 parts by weight of the photoinitiator, including about 2 to about 5 parts by weight (all amounts based upon 100 total parts of polyfunctionalized diene monomer-containing polymer and chain extender). The foregoing amounts should be understood to apply to both free radical and cationic photoinitiators and to refer to the total amounts (by weight) of all photoinitiators used in the actinic radiation curable polymeric mixture.

As discussed above, in certain embodiments, the actinic radiation curable polymeric mixture includes a photosensitizer. In other words, in certain embodiments, the photosensitizer is optional. Generally, the “photosensitizer” is a light absorbing compound used to enhance the reaction of a photoinitiator; it may absorb part of the actinic radiation (light) that the photoinitiator cannot absorb and transfer the energy to the photoinitiator. Upon photoexcitation, a photosensitizer leads to energy or electron transfer to a photoinitiator.

In those embodiments where a photosensitizer is used, the amount of photosensitizer utilized can vary. (As discussed above, the photosensitizer is not necessarily present in every embodiment disclosed herein.) In certain embodiments of the first-fifth embodiments disclosed herein, when the photosensitizer is present, the actinic radiation curable polymeric mixture includes about 0.1 to about 5 parts by weight of the photosensitizer, including about 0.1 to about 2 parts by weight (all amounts based upon 100 total parts of polyfunctionalized diene monomer-containing polymer and chain extender).

When a photosensitizer is utilized, various photosensitizers are suitable for use in the actinic radiation curable polymeric mixtures. In certain embodiments of the first-fifth embodiments disclosed herein, the photosensitizer includes at least one of a ketocoumarin, a xanthone, a thioxanthone, a polycyclic aromatic hydrocarbon, and an oximester derived from aromatic ketone. Exemplary ketocoumarins are disclosed in Tetrahedron 38, 1203 (1982), and U.K. Patent Publication 2,083,832 (Specht et al.).

As discussed above, the actinic radiation curable mixture includes a polyfunctional crosslinker reactive with the functional group F of the polyfunctionalized diene monomer-containing polymer. Generally, the polyfunctional crosslinker functions to increase the amount of crosslinking within each diene polymer chain of the polyfunctionalized diene monomer-containing polymer, between (separate) diene polymer chains of polyfunctionalized diene monomer-containing polymers, or both, thereby forming a network. Generally, an increased amount of crosslinker or crosslinking will lower the Mc of the crosslinked (cured) polyfunctionalized diene monomer-containing polymer, thereby resulting in a higher modulus and a lower Eb. In certain embodiments, the polyfunctional crosslinker is a hydrocarbon or hydrocarbon derivative polyfunctionalized with a functional group F. In other words, such a crosslinker includes multiple F groups. In certain embodiments, the crosslinker is a hydrocarbon or hydrocarbon derivative polyfunctionalized with a functional group F or a functional group that is reactive with F. By reactive is meant a moiety that will bond with at least two F groups of the polyfunctionalized diene monomer-containing polymer.

Generally, the crosslinker is a polyfunctionalized hydrocarbon or hydrocarbon derivative containing at least two functional groups reactive with F. In certain embodiments, the crosslinker is di-functional and in other embodiments, the crosslinker is tri-functional, tetra-functional, or further functionalized. While the crosslinker is based upon a hydrocarbon or hydrocarbon derivative, it should be understood that it can also be polymer-like in that it can include either a single base unit or multiple, repeating base units.

Various compounds are suitable for use as the crosslinker. In certain embodiments, the crosslinker contains at least two (meth)acrylate functional groups. In certain embodiments, the crosslinker includes a polyol (meth)acrylate prepared from an aliphatic diol, triol, or tetraol containing 2-100 carbon atoms; in such embodiments, the functional group of the crosslinker is (meth)acrylate. Various crosslinkers including at least two (meth)acrylate groups are commercially available. In certain embodiments, the crosslinker includes at least one of the following: Trimethylolpropane tri(meth)acrylate, Pentaerythritol tetraacrylate, Pentaerythritol triacrylate, Trimethylolpropane ethoxylate triacrylate, Acrylated epoxidized soybean oil, Ditrimethylol Propane Tetraacrylate, Di-pentaerythritol Polyacrylate, Di-pentaerythritol Polymethacrylate, Di-pentaerythritol triacrylate, Di-pentaerythritol trimethacrylate, Di-pentaerythritol tetracrylate, Di-pentaerythritol tetramethacrylate, Di-pentaerythritol pent(meth)acrylate, Di-pentaerythritol hexa(meth)acrylate, Pentaerythritol Poly(meth)acrylate, Pentaerythritol tri(meth)acrylate, Pentaerythritol tetra(meth)acrylate, Pentaerythritol penta(meth)acrylate, Pentaerythritol hexa(meth)acrylate, Ethoxylated glycerine triacrylate, ε-Caprolactone ethoxylated isocyanuric acid triacrylate and Ethoxylated isocyanuric acid triacrylate, Tris(2-acryloxyethyl) Isocyanulate, Propoxylated glyceryl Triacrylate, ethyleneglycol diacrylate, 1,6-hexanediol diacrylate, neopentylglycol di(meth)acrylate, ethyleneglycol dimethacrylate (EDMA), polyethyleneglycol di(meth)acrylates, polypropyleneglycol di(meth)acrylates, polybutyleneglycol di(meth)acrylates, 2,2-bis(4-(meth)acryloxyethoxyphenyl) propane, 2,2-bis(4-(meth)acryloxydiethoxyphenyl) propane, di(trimethylolpropane) tetra(meth)acrylate, and combinations thereof.

In certain embodiments, the crosslinker includes a polyallylic compound prepared from an aliphatic diol, triol or tetraol containing 2-100 carbon atoms. Exemplary polyallylic compounds useful as crosslinker include those compounds including two or more allylic groups, non-limiting examples of which include triallylisocyanurate (TAIC), triallylcyanurate (TAC), and the like, and combinations thereof.

In certain embodiments, the crosslinker includes epoxy functional groups, aziridine functional groups, vinyl functional groups, allyl functional groups, or combinations thereof.

In certain embodiments, the crosslinker includes a polyfunctional amine with at least two amine groups per molecule. In certain such embodiments, the polyfunctional amine is an aliphatic amine. Exemplary polyfunctional amines include, but are not limited to, diethylene triamine, ethylene diamine, triethylene tetramine, tetraethylene pentamine, hexamethylerie diamine, 1,2-diaminocyclohexane, amino ethyl piperazine, and the like, and combinations thereof.

In certain embodiments, the polyfunctional crosslinker includes a combination of two types of functional groups, i.e., a functional group capable of crosslinking at least two diene polymer chains based upon cationic radiation and a functional group capable of crosslinking at least two diene polymer chains based upon free radical radiation. The combination of two types of functional groups may be present on the same polyfunctional crosslinker or on separate crosslinkers (i.e., each with one type of functional group). In certain embodiments, the polyfunctional crosslinker includes a combination of at least one functional group selected from acrylate groups, methacrylate groups, polyallylic groups, and polyfunctional amines with at least one functional group selected from epoxy groups, aziridine groups, vinyl groups, and allyl groups.

It is desirable for the UV-curable liquid rubber composition to be both UV-curable and thermally curable, so the electrically conductive pathway may be co-cured together with other tire components, such as the tire tread portion including the tread cap layer and the tread base layer.

All references, including but not limited to patents, patent applications, and non-patent literature are hereby incorporated by reference herein in their entirety.

While various aspects and embodiments of the compositions and methods have been disclosed herein, other aspects and embodiments will be apparent to those skilled in the art. The various aspects and embodiments disclosed herein are for purposes of illustration and are not intended to be limiting, with the true scope and spirit being indicated by the claims.

What is claimed is:

1. A pneumatic tire comprising a tread portion which comprises a tread cap layer and a tread base layer; the tread cap layer having a ground-contacting surface, and the tread cap layer being composed of a tread cap composition; and the tread base layer underlying the tread cap layer, and the tread base layer being composed of a tread base composition; wherein the tread cap layer includes at least one electrically-conductive pathway extending from the ground-contacting surface of the tread cap layer to the tread base layer, the pathway comprising a UV-cured rubber composition, wherein the UV-cured rubber composition is a UV-curable liquid rubber composition cured by UV-light.

2. The pneumatic tire of claim 1, the UV-cured rubber composition being electrically conductive.

3. The pneumatic tire of claim 2, the electrical conductivity of the UV-cured rubber composition being higher than 1×10⁶ S/cm.

4. The pneumatic tire of claim 1, the electrically-conductive pathway being formed during a tire manufacturing process, wherein the tread cap layer is in an uncured green state.

5. The pneumatic tire of claim 4, the electrically-conductive pathway being formed by steps comprising:
forming a cavity in the uncured green tread cap layer, and the cavity extending from the ground-contacting surface of the tread cap layer to the tread base layer;
filling the cavity with a UV-curable liquid rubber composition;
applying UV light to a surface of the UV-curable liquid rubber composition to form a partially UV-cured liquid rubber composition; and
co-curing the partially UV-cured liquid rubber composition with the tread cap layer during a tire curing process.

6. The pneumatic tire of claim 1, the electrically conductive pathway being formed after a tire manufacturing process, wherein the tread cap layer is in cured state.

7. The pneumatic tire of claim 6, the electrically conductive pathway being formed by steps comprising:
forming a cavity in the cured tire tread cap layer, the cavity extending from the ground-contacting surface of the tread cap layer to the tread base layer;
filling the cavity with the UV-curable liquid rubber composition while applying UV light to the UV-curable liquid rubber composition; and
further applying the UV light after filling the cavity to cure the UV-curable liquid rubber composition.

8. The pneumatic tire of claim 1, the tread cap layer being electrically non-conductive.

9. The pneumatic tire of claim 1, the tread base layer being electrically conductive.

10. The pneumatic tire of claim 1, the electrical conductivity of the tread base payer being higher than 1×10⁻⁸ S/cm.

11. The pneumatic tire of claim 1, the electrical conductivity of the tread base payer being higher than 1×10⁻⁶ S/cm.

12. The pneumatic tire of claim 1, the electrically-conductive pathway being entirely formed of the UV-cured rubber composition.

13. The pneumatic tire of claim 12, the electrically-conductive pathway being encased along its radial length by the tread cap layer.

14. The pneumatic tire of claim 1, the UV-curable liquid rubber comprising
(a) polyfunctionalized diene monomer-containing polymer having a formula: [P][F]ₙ
wherein P represents a diene polymer chain and comprises monomers selected from a group consisting of 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene, 2,4-hexadiene, 1,3-cyclopentadiene, 1,3-cyclohexadiene, 1,3-cycloheptadiene, 1,3-cyclooctadiene, farnescene, and substituted derivatives of each of the foregoing;
F represents a functional group, n is 2 to about 15, and each F can be the same or different; each F comprises at least one of: acrylate, methacrylate, cyanoacrylate, epoxide, aziridine, and thioepoxide.
(b) optionally a chain extender based upon F or reactive with F;
wherein the chain extender comprising an (meth)acrylate monomer selected from C2 to about C18 alkyl functionalized (meth)acrylates with T_{g} of about −65° C. to about 10° C. and a number average molecular weight of about 70 to about 135,000 grams/mole;
(c) at least one actinic radiation sensitive photoinitiator;
(d) optionally, a photosensitizer;
(e) a polyfunctional crosslinker reactive with F; and
(f) at least one electrically-conductive filler selected from a group consisting of conductive grades of carbon black, reinforcing grades of carbon black, silica, carbon nanotube, graphene, expanded graphite, metal particles, electrically-conductive polymers, and doped electrically-conductive polymers.

15. The pneumatic tire of claim 14, the photoinitiator in the UV-curable liquid rubber composition satisfying one of the following conditions:
a. the photoinitiator comprises at least one of: a benzophenone, an aromatic α-hydroxyketone, a benzilketal, an aromatic α-aminoketone, a phenylglyoxalic acid ester, a mono-acylphosphinoxide, a bis-acylphosphinoxide, and a tris-acylphosphinoxide;
b. the photoinitiator is selected from the group consisting of benzophenone, benzildimethylketal, 1-hydroxy-cyclohexyl-phenyl-ketone, 1-[4-(2-hydroxyethoxy)-phenyl]-2-hydroxy-2-methyl-1-propan-1one, 2-hydroxy-1-{4-[4-(2-hydroxy-2-methyl-propionyl)-benzyl]-phenyl}-2-methyl-propan-1-one, (4-methylthiobenzoyl)-1-methyl-1-morpholinoethane, (4-morpholinobenzoyl)-1-benzyl-1-dimethylaminopropane, (4-morpholinobenzoyl)-1-(4-methylbenzyl)-1-dimethylaminopropane, (2,4,6-trimethylbenzoyl)diphenylphosphine oxide, bis(2,6-dimethoxy-benzoyl)-(2,4,4-trimethyl-pentyl)phosphine oxide, bis(2,4,6-trimethylbenzoyl)-phenylphosphine oxide and 2-hydroxy-1-{1-[4-(2-hydroxy-2-methyl-propionyl)-phenyl]-1,3,3-trimethyl-indan-5-yl}-2-methyl-propan-1-one, 1,2-octanedione, 1-[4-(phenylthio)phenyl]-,2-(O-benzyloxime), oligo[2-hydroxy-2-methyl-1-[4-methylvinyl]phenyl]propanone, 2-hydroxy-2-methyl-1-phenyl propan-1-one, and combinations thereof; or
c. the photoinitiator comprises at least one of: a benzoin, an aryl ketone, an alpha-amino ketone, a mono- or bis(acyl)phosphine oxide, a benzoin alkyl ether, a benzil ketal, a phenylglyoxalic ester or derivatives thereof, an oxime ester, a per-ester, a ketosulfone, a phenylglyoxylate, a borate, and a metallocene.

16. The pneumatic tire of claim 14, the photosensitizer being selected from a group consisting of ketocoumarin, xanthone, thioxanthone, polycyclic aromatic hydrocarbon, and oximester derived from aromatic ketone.

17. The pneumatic tire of claim 14, the polyfunctional crosslinker in the UV-curable liquid rubber composition meeting at least one of the following:
a. the polyfunctional crosslinker is selected from the group consisting of polyol (meth)acrylates prepared from an aliphatic diol, triol, or tetraol containing 2-100 carbon atoms, polyallylic compounds prepared from an aliphatic diol, triol or tetraol containing 2-100 carbon atoms, polyfunctional amines, or combinations thereof; or
b. the polyfunctional crosslinker is selected from the group consisting of trimethylolpropane tri(meth)acrylate, pentaerythritol tetraacrylate, pentaerythritol triacrylate, trimethylolpropane ethoxylate triacrylate, acrylated epoxidized soybean oil, ditrimethylol propane tetraacrylate, di-pentaerythritol polyacrylate, di-pentaerythritol polymethacrylate, di-pentaerythritol triacrylate, di-pentaerythritol trimethacrylate, di-pentaerythritol tetracrylate, di-pentaerythritol tetramethacrylate, di-pentaerythritol pent(meth)acrylate, di-pentaerythritol hexa(meth)acrylate, pentaerythritol poly(meth)acrylate, pentaerythritol tri(meth)acrylate, pentaerythritol tetra(meth)acrylate, pentaerythritol penta(meth)acrylate, pentaerythritol hexa(meth)acrylate, ethoxylated glycerine triacrylate, ε-caprolactone ethoxylated isocyanuric acid triacrylate and ethoxylated isocyanuric acid triacrylate, tris(2-acryloxyethyl) isocyanulate, propoxylated glyceryl triacrylate, ethyleneglycol diacrylate, 1,6-hexanediol diacrylate, neopentylglycol di(meth)acrylate, ethyleneglycol dimethacrylate (EDMA), polyethyleneglycol di(meth)acrylates, polypropyleneglycol di(meth)acrylates, polybutyleneglycol di(meth)acrylates, 2,2-bis(4-(meth)acryloxyethoxyphenyl) propane, 2,2-bis(4-(meth)acryloxydiethoxyphenyl) propane, di(trimethylolpropane) tetra(meth)acrylate, and combinations thereof.

18. The pneumatic tire of claim 14, the UV-curable liquid rubber composition further comprising a thermally-curable organic peroxide package, wherein thermally-curable organic peroxide package comprises an organic peroxide and optionally a coagent, wherein the organic peroxide is selected from the group consisting of dicumyl peroxide and α,α′-bis(t-butylperoxy)diisopropylbenzene, and the coagent is selected from the group consisting of octyl acrylate, decyl acrylate, 1,6-hexanediol diacrylate, zinc diacrylate, zinc dimethacrylate, trimethylolpropane triacrylate, pentaerythritol tetraacrylate, dipentaerythritol pentaacrylate, triallyl cyanurate, triallyl isocyanurate, high vinyl polybutadiene, and mixtures thereof.

19. A method of making a tire capable of dissipating electrostatic charge generated in a vehicle, the method comprising steps of:
forming a cavity into a tread cap layer of a tire extending from a ground-contacting surface of the tread cap layer to a tread base layer underlying the tread cap layer,
filling a UV-curable liquid rubber composition into the cavity in the tread cap layer, and
exposing a surface of the UV-curable liquid rubber composition to UV-light to partially cure the UV-curable liquid rubber composition.

20. The method of claim 19, the tread cap layer being in an uncured green state, wherein the method further comprises co-curing the UV-curable liquid rubber composition with the uncured green tread cap layer.
